(19) United States
(12) Patent Application Publication
(10) Pub. No.: US 2025/0375706 A1
(43) Pub. Date: Dec. 11, 2025

(54) CONTROL INTERACTION

(71) Applicant: TENCENT TECHNOLOGY (SHENZHEN) COMPANY LIMITED, Shenzhen (CN)

(72) Inventors: Xuyang GUO, Shenzhen (CN); Yizhong HU, Shenzhen (CN); Zongshi MO, Shenzhen (CN); Wen LU, Shenzhen (CN)

(73) Assignee: TENCENT TECHNOLOGY (SHENZHEN) COMPANY LIMITED, Shenzhen (CN)

(21) Appl. No.: 19/313,106

(22) Filed: Aug. 28, 2025

Related U.S. Application Data
(63) Continuation of application No. PCT/CN2024/083447, filed on Mar. 25, 2024.

(30) Foreign Application Priority Data
May 23, 2023 (CN) 202310591322.7

(51) Int. Cl. A63F 13/537; G06F 3/04815; G06F 3/0484; G06T 13/20

(52) U.S. Cl. CPC A63F 13/537; G06T 13/20; G06F 3/04815; G06F 3/0484; G06T 2200/24

(57) ABSTRACT

In a control interaction method, a three-dimensional polyhedral control element that includes a plurality of functional faces is displayed on a first user interface of an application. Each of the plurality of functional faces corresponds to a respective one of a plurality of functions provided by the application. For a target functional face of the plurality of functional faces that is a front-facing display surface of the three-dimensional polyhedral control element, function information of a target function that corresponds to the target functional face is displayed. The target function is performed based on a first selection operation being performed on the target functional face of the three-dimensional polyhedral control element. Apparatus and non-transitory computer-readable storage medium counterpart embodiments are also contemplated.

### RELATED APPLICATIONS

The present application is a continuation of International Application No. PCT/CN2024/083447, filed on Mar. 25, 2024, which claims priority to Chinese Patent Application No. 202310591322.7, filed on May 23, 2023. The entire disclosures of the prior applications are hereby incorporated by reference.

### FIELD OF THE TECHNOLOGY

This disclosure relates to the field of computer technologies, including to a control interaction technology.

### BACKGROUND OF THE DISCLOSURE

With the rapid development of Internet technologies and computer technologies, many applications (APPs) provide more diversified functions for users thereof. For example, a game APP may provide more game modes for players to experience.

In a related technology, use entries of various functions provided by an APP for a user may be displayed in a tiled manner on a specific interface of the APP. For example, in a game APP, experience entries of various game modes are directly displayed in a tiled manner on a game hall interface. However, as functions provided by APPs increase, layouts of interfaces become more congested. Thus, a related manner of displaying function use entries has poor space utilization and poor scalability for an interface.

### SUMMARY

Aspects of this disclosure provide a control interaction method and a related apparatus. By changing a deployment manner of function use entries in an interface, space utilization of the interface can be improved, and scalability of the interface can be enhanced, so that the interface can more reasonably carry more function use entries.

According to an aspect, a control interaction method is provided. In the method, a three-dimensional polyhedral control element that includes a plurality of functional faces is displayed on a first user interface of an application. Each of the plurality of functional faces corresponds to a respective one of a plurality of functions provided by the application. For a target functional face of the plurality of functional faces that is a front-facing display surface of the three-dimensional polyhedral control element, function information of a target function that corresponds to the target functional face is displayed. The target function is performed based on a first selection operation being performed on the target functional face of the three-dimensional polyhedral control element.

According to an aspect, an information processing apparatus is provided. The information processing apparatus includes processing circuitry. The processing circuitry is configured to display, on a first user interface of an application, a three-dimensional polyhedral control element that includes a plurality of functional faces, each of the plurality of functional faces corresponding to a respective one of a plurality of functions provided by the application. The processing circuitry is configured to display, for a target functional face of the plurality of functional faces that is a front-facing display surface of the three-dimensional polyhedral control element, function information of a target function that corresponds to the target functional face. The processing circuitry is configured to perform the target function based on a first selection operation being performed on the target functional face of the three-dimensional polyhedral control element.

According to an aspect, this disclosure provides a control interaction method, performed by an electronic device and including displaying a three-dimensional polyhedral control on a first interface of a target application. The three-dimensional polyhedral control includes a plurality of functional faces, the plurality of functional faces corresponding to a plurality of functions in the target application. The method includes displaying, when a target functional face is a main display surface of the three-dimensional polyhedral control, introduction information of a target function corresponding to the target functional face; the target functional face being any one of the plurality of functional faces, and the main display surface being a functional face on the three-dimensional polyhedral control and directly facing a display screen. The method includes displaying a second interface corresponding to the target function if a start-to-use operation on the target function and triggered based on the target functional face is received.

According to an aspect, this disclosure provides a control interaction apparatus, including a control display module, an information display module, and an interface jump module. The control display module is configured to display a three-dimensional polyhedral control on a first interface of a target application. The three-dimensional polyhedral control includes a plurality of functional faces, the plurality of functional faces corresponding to a plurality of functions in the target application. The information display module is configured to display, when a target functional face is a main display surface of the three-dimensional polyhedral control, introduction information of a target function corresponding to the target functional face; the target functional face being any one of the plurality of functional faces, and the main display surface being a functional face on the three-dimensional polyhedral control and directly facing a display screen. The interface jump module is configured to display a second interface corresponding to the target function if a start-to-use operation on the target function and triggered based on the target functional face is received.

According to an aspect, this disclosure provides an electronic device, including a processor and a memory. The memory is configured to store a computer program. The processor is configured to perform, according to the computer program, one or more methods of the present disclosure.

According to an aspect, this disclosure provides a non-transitory computer-readable storage medium, the non-transitory computer-readable storage medium storing instructions which when executed by a processor, cause the processor to perform one or more methods of the present disclosure.

According to an aspect, this disclosure provides a computer program product or a computer program, the computer program product or the computer program including computer instructions, the computer instructions being stored in a computer-readable storage medium. A processor of a computer device reads the computer instructions from the computer-readable storage medium, and the processor executes the computer instructions, causing the computer device to perform one or more methods of the present disclosure.

As can be seen from the foregoing technical solutions, the aspects of this disclosure include the following advantages:

An aspect of this disclosure provides a control interaction method. According to the method, a three-dimensional polyhedral control is displayed on a first interface of a target application, the three-dimensional polyhedral control includes a plurality of functional faces, and the plurality of functional faces correspond to a plurality of different functions in the target application. The functions in the target application are presented by using the functional faces of the three-dimensional polyhedral control. On the one hand, compared with displaying function controls in a tiled manner on an interface in the related technology, a space occupied by the function controls on the interface may be reduced. On the other hand, when functions in the target application are increased, a space occupied by the three-dimensional polyhedral control on the first interface may not increase as the functions increase, thereby improving utilization and scalability of an interface space. When a target functional face is a main display surface of the three-dimensional polyhedral control, introduction information of a target function corresponding to the target functional face is displayed, where the main display surface is a functional face on the three-dimensional polyhedral control and directly facing a display screen. A second interface corresponding to the target function is displayed if a start-to-use operation on the target function and triggered based on the target functional face is received. In this way, use of the target function is conveniently and quickly triggered based on the three-dimensional polyhedral control. As can be seen, a plurality of function use entries of a target application is presented in an interface space by using a three-dimensional polyhedral control including a plurality of functional faces, thereby simplifying a layout of the interface space, expanding a quantity of function controls that can be carried in a limited interface space, and improving utilization of the interface space.

### BRIEF DESCRIPTION OF THE DRAWINGS

FIG. 1 is a schematic diagram of an application scenario of a control interaction method according to an aspect of this disclosure.

FIG. 2 is a method flowchart of a control interaction method according to an aspect of this disclosure.

FIG. 3 is a schematic diagram of a corresponding relationship between functional faces and functions of a three-dimensional polyhedral control according to an aspect of this disclosure.

FIG. 4 is a schematic diagram of a presentation effect of a function map in a gaming application according to an aspect of this disclosure.

FIG. 5 is a schematic diagram of controlling, by using a swipe operation, a three-dimensional polyhedral control to rotate according to an aspect of this disclosure.

FIG. 6 is a schematic diagram of controlling, by using a click/tap operation, a three-dimensional polyhedral control to rotate according to an aspect of this disclosure.

FIG. 7 is a schematic diagram of an example of a first interface according to an aspect of this disclosure.

FIG. 8 is a schematic diagram of unfolding of a first interface according to an aspect of this disclosure.

FIG. 9 is a schematic diagram of an unfolding effect of a three-dimensional polyhedral control according to an aspect of this disclosure.

FIG. 10 is a schematic diagram of an unfolding effect of a three-dimensional polyhedral control according to an aspect of this disclosure.

FIG. 11 is a flowchart of interaction when a three-dimensional polyhedral control is clicked/tapped and rotated according to an aspect of this disclosure.

FIG. 12 is a schematic structural diagram of a control interaction apparatus according to an aspect of this disclosure.

FIG. 13 is a schematic structural diagram of a terminal device according to an aspect of this disclosure.

FIG. 14 is a schematic structural diagram of a server according to an aspect of this disclosure.

### DETAILED DESCRIPTION

To enable a person skilled in the art to better under the solutions of this disclosure, the following describes the technical solutions of the aspect of this disclosure with reference to the accompanying drawings. The described aspects are merely some rather than all of the aspects of this disclosure. All other aspects obtained by a person of ordinary skill in the art based on the aspects of this disclosure shall fall within the scope of this disclosure.

Examples of terms involved in the aspects of the disclosure are briefly introduced. The descriptions of the terms are provided as examples only and are not intended to limit the scope of the disclosure. The terms such as “first”, “second”, “third”, and “fourth” (if any) in the specification and claims of this disclosure and in the accompanying drawings are used for distinguishing similar objects and not necessarily used for describing any particular order or sequence. Such used data is interchangeable where appropriate so that the aspects of this disclosure described here can be implemented in an order other than those illustrated or described here. Moreover, the terms “include/comprise”, “have”, and any other variants thereof mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

Nowadays, many APPs provide abundant functions. To present functions in an APP to a user, a developer may deploy use entries of the functions on a specific interface of the APP in a tiled manner, enabling the user to view the functions of the APP on the specific interface. However, as the APP is updated and upgraded, the functions provided by the APP may gradually increase. When the APP provides more functions, an interface layout of the APP becomes congested by presenting use entries of all the functions in a tiled manner on a specific interface of the APP, which is not beneficial for the user to quickly find a use entry of a required function, leading to poor use experience of the user.

To this end, aspects of this disclosure provide a control interaction method and a related apparatus. In a target application, a plurality of different functions in the target application are presented by using a plurality of functional faces in a three-dimensional polyhedral control, thereby improving utilization and scalability of an interface space.

The control interaction method provided in the aspects of this disclosure may be performed by an electronic device. The electronic device may be a terminal device. The terminal device includes, but is not limited to, a mobile phone, a computer, an intelligent voice interaction device, a smart home appliance, a vehicle-mounted terminal, and the like. The terminal device may be connected directly or indirectly to a backend server in a wired communication manner or a wireless communication manner, which is not limited in this disclosure.

To facilitate understanding of the control interaction method provided in the aspects of this disclosure, an example application scenario of the control interaction method is described below.

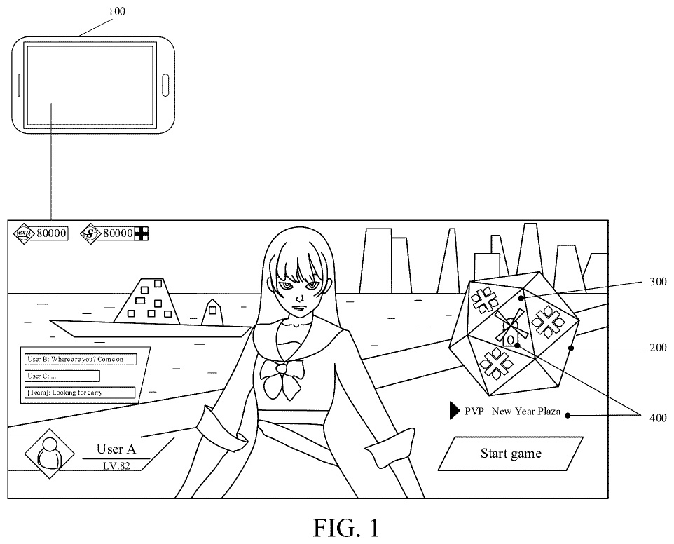

FIG. 1 is a schematic diagram of an application scenario of a control interaction method according to an aspect of this disclosure. In the scenario shown in FIG. 1, an example in which the terminal device 100 is used as the foregoing electronic device configured to perform the control interaction method provided in this aspect of this disclosure is used for description.

As shown in FIG. 1, the target application may be a gaming application. In an actual application, the target application may alternatively be another type of application, which is not limited in this aspect of this application. A three-dimensional polyhedral control 200 including a plurality of functional faces is displayed on a first interface of the target application. A plurality of different functions provided by the target application may be presented to a user by using the plurality of functional faces of the three-dimensional polyhedral control 200.

In the target application, the three-dimensional polyhedral control 200 is a polyhedral model in which functional faces corresponding to a plurality of different functions are integrated. Compared with presentation of use entries of the functions in a tiled manner, the functional faces respectively corresponding to the plurality of functions are integrated and displayed on one three-dimensional polyhedral control 200, which can greatly save an interface space and improve utilization of the interface space. In addition, when the target application needs to provide a new function, the developer may directly increase a quantity of faces of the foregoing three-dimensional polyhedral control 200, to obtain a corresponding functional face configured for carrying the new function. Moreover, increasing the quantity of faces on the three-dimensional polyhedral control 200 does not cause a display region of the three-dimensional polyhedral control 200 to be increased on the first interface. That is, a layout of the interface neither clearly changes as the functions provided by the APP increase nor becomes more congested, and the interface has stronger scalability. When utilization and scalability of the interface space are improved, presentation of other information such as game asset information, chat information, and user information may be further added to the first interface, so as to make more effective use of the first interface.

In the three-dimensional polyhedral control 200, each functional face is associated with introduction information of a function corresponding thereto. The functional face directly facing a display screen is a current main display surface 300 of the three-dimensional polyhedral control 200. For a “New Year Plaza” functional face shown in FIG. 1, a function map corresponding to “New Year Plaza” is displayed on the main display surface, and the function map may also be considered as introduction information 400 of a “New Year Plaza” function. On the first interface of the target application, a text description of a function corresponding to the main display surface 300 is further displayed below the three-dimensional polyhedral control 200, for example, “PVP|New Year Plaza” shown in FIG. 1. The text description may also be considered as the introduction information 400 of the “New Year Plaza” function. That is, in this aspect of this disclosure, the introduction information associated with the functional face may be a function map (corresponding to the function corresponding to the functional face) on the functional face, or may be a text description of the function corresponding to the functional face. A form of the foregoing introduction information is not specifically limited in this aspect of this disclosure. In addition, when the introduction information of the function corresponding to the main display surface is displayed on the first interface, the function map and the text description may be displayed at the same time, or either of the two may be displayed, which is not specifically limited in this aspect of this disclosure.

On the first interface shown in FIG. 1, the user may perform an interactive operation with the three-dimensional polyhedral control 200 to control the three-dimensional polyhedral control 200 to rotate, so as to switch the main display surface 300 to enable the user to view various functions in a target application.

When “New Year Plaza” is a target function that the user wants to invoke, a functional face corresponding to the target function is a target functional face. The user may perform an interactive operation with the three-dimensional polyhedral control 200 to control the three-dimensional polyhedral control 200 to rotate, enabling the target functional face on the three-dimensional polyhedral control 200 to rotate to a position directly facing the screen. Even if the target functional face becomes the main display surface 300, as shown in FIG. 1, after a target functional face corresponding to the target function “New Year Plaza” is the main display surface 300 of the three-dimensional polyhedral control 200, introduction information 400 of the target function associated with the target functional face is displayed on the first interface, including a type “PVP” and a function name “New Year Plaza” of the target function as well as a function map carried by using the main display surface 300.

When the user clicks/taps a “Start Game” control on the first interface, the terminal device 100 may trigger and start, based on the target functional face “New Year Plaza”, the target function “New Year Plaza” in response to a start-to-use operation on the target function, and a second interface corresponding to the target function is entered. The start-to-use operation on the target function may be triggered by clicking/tapping the “Start Game” control, or the start-to-use operation on the target function may be implemented in another manner such as double-clicking/tapping or long-pressing the main display surface, which is not specifically limited in this aspect of this disclosure.

That is, in the interface space of the target application running on the terminal device 100, a plurality of different functions in the target application are presented by using the plurality of functional faces of the three-dimensional polyhedral control 200, thereby simplifying a layout in the interface space of the target application. Since a space occupied by the three-dimensional polyhedral control 200 in the interface space is limited, when functions in the target application are increased, the increased functions are displayed by adding functional faces to the three-dimensional polyhedral control 200, which may not affect the space occupied by the three-dimensional polyhedral control 200 in the interface space, thereby increasing a number of functions that can be carried in the limited interface space, improving scalability of the interface space, and also improving utilization of the interface space. Through the interactive operation between the user and the three-dimensional polyhedral control 200, the user may view introduction information of functions corresponding to the functional faces in the three-dimensional polyhedral control 200, thereby enhancing interactivity between the user and the three-dimensional polyhedral control 200 and improving use experience of the user for the target application.

The application scenario shown in FIG. 1 is merely an example. In an actual application, the control interaction method provided in this aspect of this disclosure may also be applied to other scenarios, for example, may be applied to various applications such as a social application, a shopping application, an audio playback application, and a video playback application, which is not limited in this aspect of this disclosure.

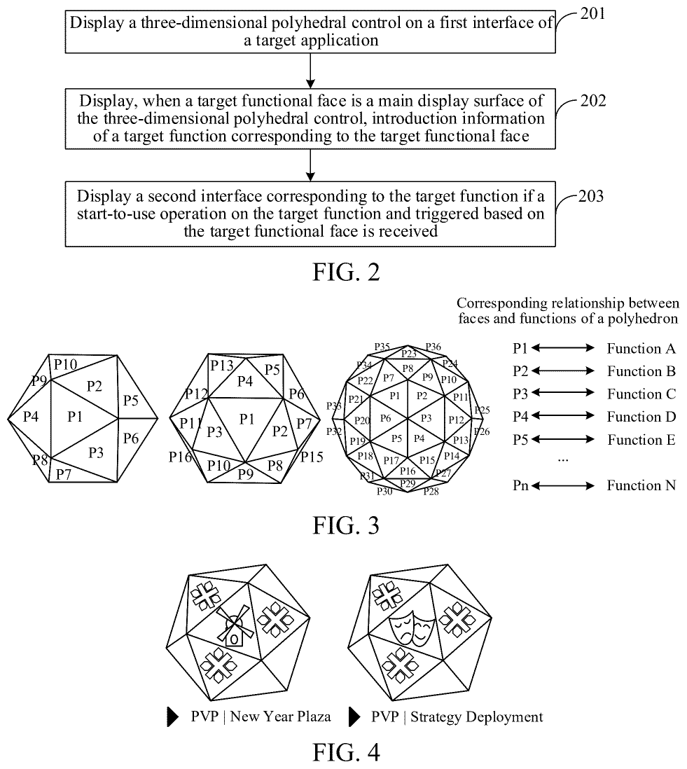

FIG. 2 is a method flowchart of a control interaction method according to an aspect of this disclosure. The method may be performed by a terminal device used as the foregoing electronic device. As shown in FIG. 2, the method specifically includes the following operations:

Operation 201: Display a three-dimensional polyhedral control on a first interface of a target application. In an example, a three-dimensional polyhedral control element that includes a plurality of functional faces is displayed on a first user interface of an application. Each of the plurality of functional faces corresponds to a respective one of a plurality of functions provided by the application.

In this aspect of this disclosure, the target application is an APP installed in the terminal device and providing a plurality of use functions for the user. For example, the target application may be various application programs such as a game application, a social application, and a shopping application. The plurality of use functions provided by the target application may be presented on the first interface of the target application. The first interface is an interface that is in the target application, carries some or all functions in the target application, and displays the carried functions. In this aspect of this disclosure, the first interface may be any interface in the target application, for example, a game hall interface, a mode selection interface, or a commodity classification interface.

The three-dimensional polyhedral control is displayed on the first interface of the target application. A three-dimensional polyhedron is a three-dimensional geometric model formed by four or more polygons, and the three-dimensional polyhedral control is a visual model that sets attributes and parameters for the three-dimensional geometric model through computer programming. A plane shown by a polygon is a face of the three-dimensional polyhedron, which corresponds to a function in the target application. Then, the “face” is a functional face in the three-dimensional polyhedral control. In this aspect of this disclosure, the three-dimensional polyhedral control includes a plurality of functional faces, the plurality of functional faces correspond to a plurality of different functions in the target application, and each functional face of the three-dimensional polyhedral control is associated with introduction information of the function corresponding to the functional face. The introduction information of the function is description information for specifically describing the function. On the first interface, by displaying the introduction information associated with the functional faces, the user can learn a corresponding relationship between the functions and the functional faces carried on the first interface. In this aspect of this disclosure, the introduction information may be in a plurality of forms. For example, the introduction information may be a function map on a functional face of the three-dimensional polyhedral control or may be a text description corresponding to the function, and the text description may specifically include a function type and a function name corresponding to the function, which is not specifically limited in this disclosure.

Referring to FIG. 3, different three-dimensional polyhedral controls may include different quantities of functional faces. In this aspect of this disclosure, a corresponding three-dimensional polyhedral control may be used based on a quantity of functions that the target application needs to carry by using the first interface. For example, when the target application needs to carry four functions by using the first interface, a three-dimensional tetrahedral control including four functional faces may be used, and when the first interface of the target application carries a larger quantity of functions, a three-dimensional polyhedral control including a larger number of functional faces is used, so that a quantity of functions on the first interface is the same as a quantity of functional faces in the three-dimensional polyhedral control, and the functions are in a one-to-one correspondence to the functional faces, as shown in FIG. 3. When n different functions of the target application need to be carried on the first interface, a functional face P1 in the three-dimensional polyhedral control corresponds to a function A in the target application, a functional face P2 in the three-dimensional polyhedral control corresponds to a function B in the target application, . . . , and a functional face Pn in the three-dimensional polyhedral control corresponds to a function N in the target application. In the three three-dimensional polyhedral controls shown in FIG. 3, as the functional faces in the three-dimensional polyhedral control increase, a shape of the three-dimensional polyhedral control may gradually approach a sphere. However, in this case, the three-dimensional polyhedral control may not occupy an excessive space on the first interface. Instead, stability of the space occupied by the three-dimensional polyhedral control is maintained by reducing an area of a single functional face on the three-dimensional polyhedral control.

In this aspect of this disclosure, the functional faces of the three-dimensional polyhedral control may alternatively be repeated. For example, when the first interface carries only three different functions of the target application, since the three-dimensional polyhedral control includes at least four functional faces, in the three-dimensional polyhedral control, the fourth functional face may correspond to any one of the three different functions, and introduction information associated with a plurality of functional faces corresponding to a same function is the same. When a new function is added to the target application, the fourth functional face then corresponds to the new function. In another example, in an actual application, a quantity of functional faces corresponding to a function may be set according to a related service requirement. For example, for a function that is relatively frequently used or a new function that needs to be promoted, a plurality of functional faces may be deployed in the three-dimensional polyhedral control to correspond to the function. A mechanism for setting the quantity of the functional faces is not limited in this aspect of this disclosure.

Specifically, when the three-dimensional polyhedral control is established in the target application, to improve a visual effect of a layout of the first interface in the target application, the three-dimensional polyhedral control may alternatively be generated by using a three-dimensional polyhedral model in a shape of a regular polyhedron. In the three-dimensional polyhedral control corresponding to the regular polyhedron, the functional faces have the same shape and size. Certainly, in an actual application, functional faces of different shapes and sizes may be set for different functions to correspond thereto. For example, for a function that is relatively frequently used or a new function that needs to be promoted, a functional face having a relatively large area may be set in the three-dimensional polyhedral control to correspond thereto. Shapes and sizes of the functional faces in the three-dimensional polyhedral control are not limited herein in this aspect of this disclosure.

Operation 202: Display, when a target functional face is a main display surface of the three-dimensional polyhedral control, introduction information of a target function corresponding to the target functional face. In an example, for a target functional face of the plurality of functional faces that is a front-facing display surface of the three-dimensional polyhedral control element, function information of a target function that corresponds to the target functional face is displayed.

In this aspect of this disclosure, the target function is any one of functions respectively corresponding to a plurality of functional faces in the three-dimensional polyhedral control, which may specifically be a function that the user wants to invoke in the target application, and the target functional face is a functional face corresponding to the target function in the three-dimensional polyhedral control. On the first interface of the target application, the user may interact with the three-dimensional polyhedral control, control the three-dimensional polyhedral control to rotate, to browse functional faces on the three-dimensional polyhedral control, learn about functions carried on the first interface and a corresponding relationship between the functions and the functional faces by using introduction information of functions associated with the functional faces, and control, based on the corresponding relationship, the three-dimensional polyhedral control to rotate to cause the target functional face corresponding to the target function to be the main display surface.

The main display surface (for example, a front-facing surface) is a functional face on the three-dimensional polyhedral control and directly facing the display screen or a user. On the first interface, when a functional face on the three-dimensional polyhedral control directly faces the display screen, the functional face is the main display surface of the three-dimensional polyhedral control. In this case, all content on the functional face can be completely displayed, and content display may not be incomplete due to angle deflection or occlusion of another functional face. In addition, introduction information of a function associated with the functional face may be further displayed, to help the user to quickly and directly learn the introduction information of the function associated with the functional face.

If the target functional face corresponding to the target function is the main display surface of the three-dimensional polyhedral control, the terminal device may display introduction information of the target function associated with the current main display surface on the first interface based on a corresponding relationship between target functions and target functional faces, so that the user confirms whether to invoke the target function based on the main display surface.

In a possible implementation, the displaying introduction information of the target function corresponding to the target functional face described in operation 202 may be implemented in the following manner:

Operation 11: Display a function map corresponding to the target function on the main display surface of the three-dimensional polyhedral control.

To present the target function corresponding to the main display surface to the user more intuitively, the function map corresponding to the target function is displayed on the main display surface of the three-dimensional polyhedral control. The function map is an image (which may be a static image or a dynamic image) configured for showing a characteristic of the target function, and the function map may alternatively be a visual description manner set for a function corresponding thereto. The user may intuitively understand related information of the target function by using a vivid function map on the main display surface, thereby simplifying an interface layout of the first interface and improving use experience of the user.

For example, in this aspect of this disclosure, the function map may be configured for presenting various functional characteristics such as a game scenario in a gaming application, a chat form in a social application, and a promotion activity in a shopping application, which is not specifically limited in this aspect of this disclosure.

For example, when the target application is a gaming application and the first interface is a game hall interface in the gaming application, on the game hall interface, the plurality of functions respectively corresponding to the plurality of functional faces in the three-dimensional polyhedral control may be a plurality of game modes in the gaming application. The function map corresponding to the target function is displayed on the main display surface of the three-dimensional polyhedral control, and the function map may be a picture presenting a characteristic such as a game scenario or a game attribute of the corresponding game mode, so that the user can intuitively learn the characteristic of the game mode corresponding to the target function, facilitating the user to select a game mode in which the user is interested. As shown in FIG. 4, a game scenario of a game mode “New Year Plaza” is presented by using a plaza building in the game scenario corresponding to the game mode “New Year Plaza”, and a game attribute “Wisdom” corresponding to a game mode “Strategy Deployment” is reflected by using a double-sided mask.

Operation 12: Display text information corresponding to the target function in a polyhedron-associated region of the first interface.

In this aspect of this disclosure, the polyhedron-associated region is a region configured for displaying text information related to the target function corresponding to the main display surface, and the text information is a text description corresponding to the target function. The text description may include a function type and a function name corresponding to the target function. For example, in FIG. 4, “New Year Plaza” and “Strategy Deployment” are two different function names, and “PVP” is a function type corresponding to the foregoing two different function names.

On the first interface, a display position of the polyhedron-associated region may be determined according to a display position of the three-dimensional polyhedral control. When the three-dimensional polyhedral control is displayed on a right side of the first interface, correspondingly, the display position of the polyhedron-associated region is also disposed on the right side of the first interface, so as to intuitively reflect an association relationship between the three-dimensional polyhedral control and the polyhedron-associated region.

In this aspect of this disclosure, the display position of the polyhedron-associated region may be determined to be a position above, below, on the left, or on the right of the three-dimensional polyhedral control, or another position that is around the three-dimensional polyhedral control and can reflect mutual association between the two may be determined, which is not specifically limited in this application.

In addition, in this aspect of this disclosure, a display manner of the introduction information corresponding to the target function on the first interface may be set according to an actual service requirement. For example, the function map and the text information that correspond to the target function are both displayed on the first interface, or only the function map corresponding to the target function is displayed on the first interface, or only the text information corresponding to the target function is displayed on the first interface, which is not specifically limited in this disclosure.

In this way, by displaying the introduction information of the target function associated with the target functional face in the foregoing manner, characteristics of the target function are presented vividly, and the layout of the interface is simplified, so that the user can intuitively learn related information of a current target function, to facilitate the user to determine whether to use the target function accordingly, thereby improving use experience of the user.

Further, the method described with operation 11 and operation 12 may further include the following operations:

Operation 13: Display a default map on another functional face in the three-dimensional polyhedral control other than the target functional face in a case that the target functional face is the main display surface of the three-dimensional polyhedral control.

To distinguish the main display surface of the three-dimensional polyhedral control from other functional faces of a non-main display surface, when the function map corresponding to the target function is displayed on the main display surface, default maps may further be displayed on the other functional faces of the non-main display surface. The default map is different from the function map. The default map is a decoration for a functional face on which the default map is located and does not need to display characteristics of a function corresponding to the functional face on which the default map is located. As shown in FIG. 4, a function map corresponding to a target function is presented on a main display surface of a three-dimensional polyhedron, and default maps are shown on other functional faces, so as to highlight the introduction information of the target function.

In the three-dimensional polyhedral control, the default maps set for the other functional faces of the non-main display surface may be the same, which are, for example, all identifiers of the target application, or may be different. For example, a plurality of different default maps are set and are displayed in various manners on the other functional faces of the non-main display surface. The foregoing descriptions are all examples, and are not understood as a limitation on this aspect of this disclosure.

In this way, by using the foregoing method, the introduction information of the target function corresponding to the main display surface in the three-dimensional polyhedral control is highlighted, which prevents interference with information displayed on other functional faces, so that the user can learn related content of a target function corresponding to a current main display surface more intuitively, thereby helping the user to accurately determine whether to use the target function accordingly.

An angle between each functional face on the three-dimensional polyhedral control and the display screen is calculated on the first interface of the target application, an angular relationship between each functional face on the three-dimensional polyhedral control and the display screen is determined, and a functional face as the main display surface on the three-dimensional polyhedral control is determined based on the angular relationship.

Specifically, by using a normal vector of a functional face on the three-dimensional polyhedral control, an angular relationship between a functional face and the display screen of the terminal device may be determined. The normal vector is a directed line segment starting from any point on the functional face, pointing to the outside of the three-dimensional polyhedral control, and perpendicular to the functional face. When the normal vector of the functional face is perpendicular to the display screen and points to an outer side of the display screen, the functional face is a functional face on the three-dimensional polyhedral control and directly facing the display screen, that is, the main display surface.

In a possible implementation, the control interaction method further includes the following operations:

Operation 21: Control, in response to a main display surface adjustment operation triggered for the three-dimensional polyhedral control, the three-dimensional polyhedral control to rotate to adjust a functional face that is used as the main display surface, and display introduction information of a function corresponding to the functional face that is used as the main display surface.

When the main display surface of the three-dimensional polyhedral control on the first interface needs to be adjusted, the user may trigger a main display surface adjustment operation on the three-dimensional polyhedral control on the first interface, and correspondingly, the main display surface adjustment operation is fed back on the first interface of the target application. The three-dimensional polyhedral control rotates on the first interface according to the main display surface adjustment operation, a functional face directly facing the display screen after the rotation stops is determined as the main display surface of the three-dimensional polyhedral control, and introduction information on the first interface is switched to introduction information of a function corresponding to a current main display surface, to present the function corresponding to the current main display interface to the user.

In this aspect of this disclosure, a rotation direction of the three-dimensional polyhedral control may be either clockwise or counterclockwise. The rotation direction of the three-dimensional polyhedral control is not limited in this aspect of this disclosure.

In this way, by using the foregoing method, the main display interface of the three-dimensional polyhedral control and function introduction information corresponding thereto may be adjusted on the first interface, facilitating the user to view each function carried on the three-dimensional polyhedral control.

In a possible implementation, the controlling, in response to a main display surface adjustment operation triggered for the three-dimensional polyhedral control, the three-dimensional polyhedral control to rotate described in operation 21 may be implemented in the following manner:

Operation 31: Receive a swipe operation triggered by a control object on the display screen.

Operation 32: Determine a rotation direction and a rotation angle of the three-dimensional polyhedral control according to a swipe direction and a swipe distance that correspond to the swipe operation.

Operation 33: Control, based on the rotation direction and the rotation angle, the three-dimensional polyhedral control to rotate.

The main display surface adjustment operation on the three-dimensional polyhedral control may be triggered by a swipe operation of the control object on the display screen of the terminal device. The swipe operation may be triggered at any position on the first interface, for example, at a position of the three-dimensional polyhedral control, which is not specifically limited in this aspect of this disclosure.

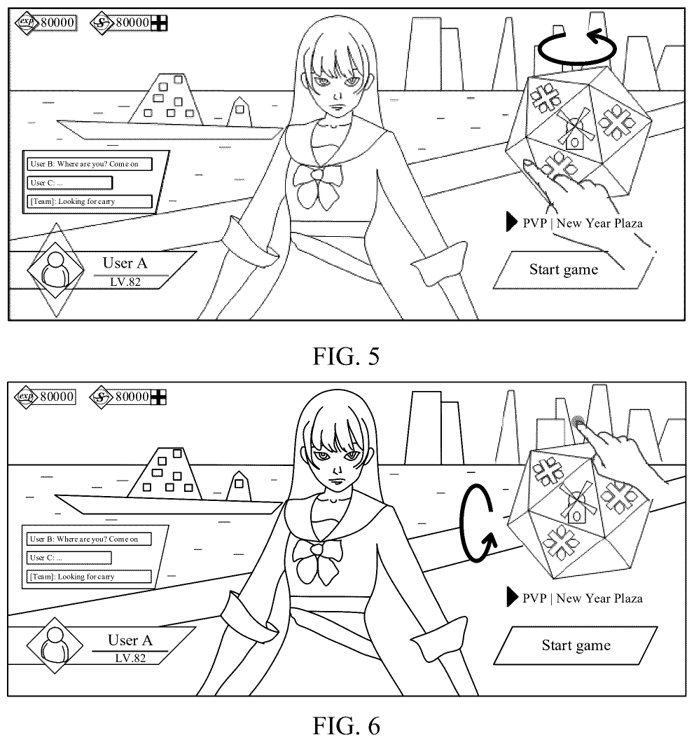

FIG. 5 is a schematic diagram of controlling, by using a swipe operation, a three-dimensional polyhedral control to rotate according to an aspect of this disclosure. As shown in FIG. 5, a swipe direction and a swipe distance of the swipe operation on the display screen may be acquired based on the swipe operation. The swipe direction is configured for determining a rotation direction of the three-dimensional polyhedral control on the first interface. For example, the rotation direction of the three-dimensional polyhedral control may be consistent with the swipe direction. That is, when the swipe direction is from a left side of the display screen to a right side of the display screen, the three-dimensional polyhedral control rotates towards a right side of the first interface accordingly. Certainly, the rotation direction of the three-dimensional polyhedral control may alternatively be determined based on deviations of the swipe direction from a horizontal direction and a vertical direction of the display screen. For example, when the swipe direction is from bottom left to top right of the display screen and the deviation between the swipe direction and the horizontal direction is no greater than the deviation from the vertical direction, it is determined that the rotation is horizontal rotation, and the three-dimensional polyhedral control needs to rotate towards the right side of the first interface. The foregoing descriptions are all examples, and are not construed as a limitation on this disclosure.

The swipe distance is configured for determining a rotation angle of the three-dimensional polyhedral control on the first interface. When the swipe distance is longer, the rotation angle of the three-dimensional polyhedral control corresponding thereto is larger. When the three-dimensional polyhedral control is deployed on the first interface, a mapping relationship between swipe distances and rotation angles may be set, and the swipe distance of the swipe operation on the display screen is mapped to the rotation angle of the three-dimensional polyhedron on the first interface by using the mapping relationship. For example, a maximum swipe distance is determined according to a size of the display screen. The maximum swipe distance is a maximum distance that can be reached by using one swipe operation, and a maximum rotation angle (e.g., 360 degrees) corresponding to the maximum swipe distance is set. The maximum rotation angle is a maximum angle that can be rotated by the three-dimensional polyhedral control controlled by using one swipe operation. A corresponding relationship between other swipe distances and rotation angles is determined based on a ratio of the maximum swipe distance to the maximum rotation angle.

The foregoing descriptions are merely examples, and the maximum swipe distance may alternatively be determined in another manner such as according to a size of a trigger region corresponding to a swipe operation on the first interface, which is not specifically limited in this aspect of this disclosure.

In this way, the three-dimensional polyhedral control is rotated by using a swipe operation of the control object on the display screen, so that a rotation effect of the three-dimensional polyhedral control on the first interface is more vivid, which improves a sense of participation of the control object and enhances interactivity between the control object and the three-dimensional polyhedral control.

Specifically, in response to the swipe operation triggered by the control object on the display screen, as the control object swipes on the display screen with a finger, an effect of dynamic rotation of the three-dimensional polyhedral control with the swiping of the finger is correspondingly presented on the first interface. After the control object loosens the finger and ends the swipe operation, a follow-up effect of the three-dimensional polyhedral control is presented on the first interface. That is, a rotation speed of the three-dimensional polyhedral control is reduced, and the rotation stops within a follow-up time, so that the rotation effect of the three-dimensional polyhedral control is more flexible. The follow-up time is a time from the end of the swipe operation to the end of the rotation of the three-dimensional polyhedral control.

Further, according to trigger and stop times of the swipe operation and a swipe distance, a swipe speed corresponding to the swipe operation may further be calculated, and the rotation speed of the three-dimensional polyhedral control is determined according to the swipe speed. When the swipe speed is higher, the rotation speed of the three-dimensional polyhedral control is also higher. In addition, according to an inertial phenomenon, when the swipe operation ends, a swipe operation at a higher swipe speed may correspond to a longer follow-up time. For example, a swipe operation at a swipe speed of v corresponds to a follow-up time of 0.1 second, and a swipe operation at a swipe speed of 2v corresponds to a follow-up time of 0.2 second, thereby further improving authenticity of the rotation effect of the three-dimensional polyhedral control.

In another possible implementation, the controlling, in response to a main display surface adjustment operation triggered for the three-dimensional polyhedral control, the three-dimensional polyhedral control to rotate described in operation 21 may be implemented in the following manner:

Operation 41: Receive a click/tap operation triggered by a control object in a control region corresponding to the three-dimensional polyhedral control.

Operation 42: Control, according to the click/tap operation and a rotation direction and a rotation angle that correspond to a preset click/tap operation, the three-dimensional polyhedral control to rotate.

The main display surface adjustment operation on the three-dimensional polyhedral control may be triggered by a click/tap operation of the control object on the display screen of the terminal device. The click/tap operation may be triggered in the control region corresponding to the three-dimensional polyhedral control on the first interface, and the control region may be disposed at any position on the first interface, which is not specifically limited in this disclosure.

FIG. 6 is a schematic diagram of controlling, by using a click/tap operation, a three-dimensional polyhedral control to rotate according to an aspect of this disclosure. As shown in FIG. 6, for example, the control region may be disposed around the three-dimensional polyhedral control, and in response to click/tap operations triggered in the control region in different orientations, the three-dimensional polyhedral control is controlled to rotate towards the orientations. Specifically, control regions may be disposed above, below, on a left side, and on a right side of the three-dimensional polyhedral control. When a click/tap operation triggered in the control region above is received, the three-dimensional polyhedral control is controlled to rotate upwards. Before the rotation, a functional face located below an original main display surface rotates to a position of the main display surface, to become a new main display surface of the three-dimensional polyhedral control. Correspondingly, when click/tap operations triggered in the control region therebelow, the control region on the left side, and the control region on the right side are received, the three-dimensional polyhedral control is controlled to rotate down, left, and right accordingly, and before the rotation, functional faces located above, on a right side, and on a left side of an original main display surface rotate to the position of the main display surface, to become a new main display surface of the three-dimensional polyhedral control.

As an example, in this aspect of this disclosure, one or more control regions may be disposed on the first interface to trigger a click/tap operation of the control object, which is not specifically limited in this aspect of this disclosure.

Further, when the main display surface is adjusted by using a click/tap operation, a sound effect or an animation effect may further be set when the main display surface is switched, so as to improve vividness of the rotation effect of the three-dimensional polyhedral control on the first interface.

When the three-dimensional polyhedral control is deployed on the first interface, a corresponding rotation angle may be preset for the click/tap operation, and each time the click/tap operation is triggered, the three-dimensional polyhedral control may rotate at the rotation angle. As an example, in this aspect of this disclosure, based on the preset rotation angle corresponding to the click/tap operation, an adjacent functional face may be switched by using one click/tap operation. That is, a functional face adjacent to a current main display surface is switched to a new main display surface, or a non-adjacent functional face may be switched by using one click/tap operation. That is, a functional face not adjacent to the current main display surface is switched to a new main display surface. The current main display surface and the new main display surface may be separated by one or more functional faces, which is not specifically limited in this aspect of this disclosure.

A rotation angle of the three-dimensional polyhedral control controlled by using one click/tap operation is not specifically limited in this aspect of this disclosure.

Further, in the control region, the control object may further control, by using a long-press operation and according to a duration of the long-press operation, the three-dimensional polyhedral control to continuously rotate. For example, the long-press operation does not last for 1 second, which is equivalent to triggering a click/tap operation. When the long-press operation lasts for 5 seconds, the three-dimensional polyhedral control is controlled to continuously rotate 5 times.

In this way, the rotation of the three-dimensional polyhedral control is controlled by using the click/tap operation of the control object in the control region, to adjust the main display surface of the three-dimensional polyhedral control, so that the rotation of the three-dimensional polyhedral control can be accurately controlled based on a preset relationship between the click/tap operation and the rotation angle, thereby improving adjustment efficiency of the main display surface.

In a possible implementation, when the three-dimensional polyhedral control is controlled to rotate based on the main display surface adjustment operation, the functional face that is used as the main display surface may be determined in the following manner:

Operation 51: Determine, for each functional face of the three-dimensional polyhedral control after the three-dimensional polyhedral control stops rotating, an angle between the functional face and a horizontal plane of the display screen as a reference angle corresponding to the functional face.

Operation 52: Determine, in the functional faces included in the three-dimensional polyhedral control, a functional face whose corresponding reference angle is closest to zero degree as the main display surface.

When the three-dimensional polyhedral control is controlled to rotate by using the main display surface adjustment operation (such as a swipe operation or a click/tap operation), since angles between different functional faces in the three-dimensional polyhedral control may be different, one functional face directly facing the display screen after each rotation may not be accurately controlled by using the main display surface adjustment operation. However, on the first interface, a functional face in the three-dimensional polyhedral control also needs to be controlled as the main display surface and is displayed directly facing the display screen. Therefore, after the rotation of the three-dimensional polyhedral control in response to the main display surface adjustment operation stops, a reference angle corresponding to each functional face needs to be calculated. The reference angle is an angle value that is between the functional face and a horizontal plane and is calculated by using the horizontal plane with the display screen as a reference. When a reference angle corresponding to a functional face is zero degree, it is considered that the functional face directly faces the display screen, and then the functional face is the main display surface of the three-dimensional polyhedral control.

In the three-dimensional polyhedral control, a functional face whose reference angle is closest to zero degree is a functional face that is in the three-dimensional polyhedral control and most meets a condition of the main display surface. Therefore, the functional face whose reference angle is closest to zero degree may be determined from the functional faces of the three-dimensional polyhedral control as the main display surface of the three-dimensional polyhedral control.

In this way, the functional face that is in the three-dimensional polyhedral control and is used as the main display surface is determined by using the foregoing method, so that efficiency and accuracy of determination of the main display surface can be improved.

Further, the foregoing method for determining a functional face of the main display surface may further include the following operations:

Operation 61: Control, if the reference angle corresponding to the functional face that is used as the main display surface is not zero degree, the three-dimensional polyhedral control to rotate to cause the reference angle corresponding to the functional face that is used as the main display surface to be zero degree.

Based on operation 52, the functional face whose reference angle is closest to zero degree is used as the main display surface of the three-dimensional polyhedral control. However, if a difference between the reference angle corresponding to the main display surface and zero degree is still large, the function map displayed on the main display surface of the first interface may be distorted with angle deflection, and content on the main display surface cannot be fully presented, leading to a poor display effect on the main display surface and further affecting the use experience of the user. Therefore, to improve the display effect of the main display surface of the three-dimensional polyhedral control on the first interface, after the three-dimensional polyhedral control stops rotating, the angle of the three-dimensional polyhedral control is further adjusted, and the reference angle corresponding to the main display surface is adjusted to zero degree, so that the main display surface directly faces the display screen of the terminal device.

In this way, by using the foregoing method, the display effect of the main display surface of the three-dimensional polyhedral control on the first interface is improved, thereby improving use experience of the user and facilitating the user to view content on the main display surface of the three-dimensional polyhedral control more completely.

Operation 203: Display a second interface corresponding to the target function if a start-to-use operation on the target function and triggered based on the target functional face is received. In an example, the target function is performed based on a first selection operation being performed on the target functional face of the three-dimensional polyhedral control element.

In this aspect of this disclosure, the user of the terminal device may interact with the three-dimensional polyhedral control on the first interface of the target application. When the user determines that the main display surface of the three-dimensional polyhedral control invokes a target function, the user may trigger a start-to-use operation on the target function based on the target functional face. After receiving the start-to-use operation on the target function, the terminal device displays the second interface corresponding to the target function on the display screen.

Specifically, after the user triggers the start-to-use operation on the target function, the target application may transmit an instruction indicating the operation to a backend server of the target application, for example, an instruction carrying information indicating use of the target function is transmitted to the backend server, and the server invokes second interface information (e.g., rendering data and operating logic data related to the second interface) corresponding to the target function in response to the instruction and feeds back the second interface information to the terminal device, so that the terminal device displays the second interface corresponding to the target function based on the received second interface information.

The second interface is a function implementation interface corresponding to the target function. When the second interface is displayed on the display screen of the terminal device, the target application is invoking the target function. In this case, the user may also use the target function by using the terminal device.

Specifically, as described above, after receiving a start-to-use operation that is triggered by the user based on the target functional face and is on the target function, the terminal device may correspondingly invoke the target function in the target application and provide the target function for the user of the terminal device for use. For example, in the scenario shown in FIG. 1, after the “New Year Plaza” functional face is the main display surface and the user confirms to use the “New Year Plaza” game mode based on the “New Year Plaza” functional face, that is, the terminal device 100 receives a start-to-use operation on the “New Year Plaza” game mode and triggered based on the “New Year Plaza” functional face, invokes the “New Year Plaza” game mode in the target application, and displays the second interface corresponding to the game mode on the display screen of the terminal device, so that the user experiences the “New Year Plaza” game mode in the target application.

An aspect of this disclosure provides a control interaction method. According to the method, a three-dimensional polyhedral control is displayed on a first interface of a target application. The three-dimensional polyhedral control includes a plurality of functional faces, and the plurality of functional faces correspond to a plurality of different functions in the target application. The functions in the target application are presented by using the functional faces of the three-dimensional polyhedral control. On the one hand, compared with displaying function controls in a tiled manner on an interface in the related technology, a space occupied by the function controls on the interface may be reduced. On the other hand, when functions in the target application are increased, a space occupied by the three-dimensional polyhedral control on the first interface may not increase as the functions increase, thereby improving utilization and scalability of an interface space. When a target functional face is a main display surface of the three-dimensional polyhedral control, introduction information of a target function corresponding to the target functional face is displayed. The main display surface is a functional face on the three-dimensional polyhedral control and directly facing a display screen. A second interface corresponding to the target function is displayed if a start-to-use operation on the target function and triggered based on the target functional face is received. In this way, use of the target function is conveniently and quickly triggered based on the three-dimensional polyhedral control. As can be seen, a plurality of function use entries of a target application are presented in an interface space by using a three-dimensional polyhedral control including a plurality of functional faces, thereby simplifying a layout of the interface space, expanding a quantity of function controls that can be carried in a limited interface space, and improving utilization of the interface space.

On the first interface, to help the user to trigger and use the target function corresponding to the main display surface, a function entry may be deployed on the first interface. When the user triggers the function entry, a function currently corresponding to the main display surface of the three-dimensional polyhedral control may be entered.

In a possible implementation, the first interface includes a second function entry control; the second function entry control supporting triggering use of a function corresponding to the main display surface of the three-dimensional polyhedral control. In this case, operation 203 may be implemented in the following manner:

displaying the second interface corresponding to the target function in response to a function use operation triggered by using the second function entry control in a case that the target functional face is the main display surface of the three-dimensional polyhedral control.

The second function entry control is a control that is deployed on the first interface and supports directly invoking a target function corresponding to the main display surface. When the second function entry control is triggered, the target application invokes the target function and switches from the first interface to the second interface corresponding to the target function, and the second interface is displayed on the display screen. The second interface is a function implementation interface corresponding to the target function, for example, a game scenario interface corresponding to a gaming application, a chat interface corresponding to a social application, or a promotion activity interface corresponding to a shopping application.

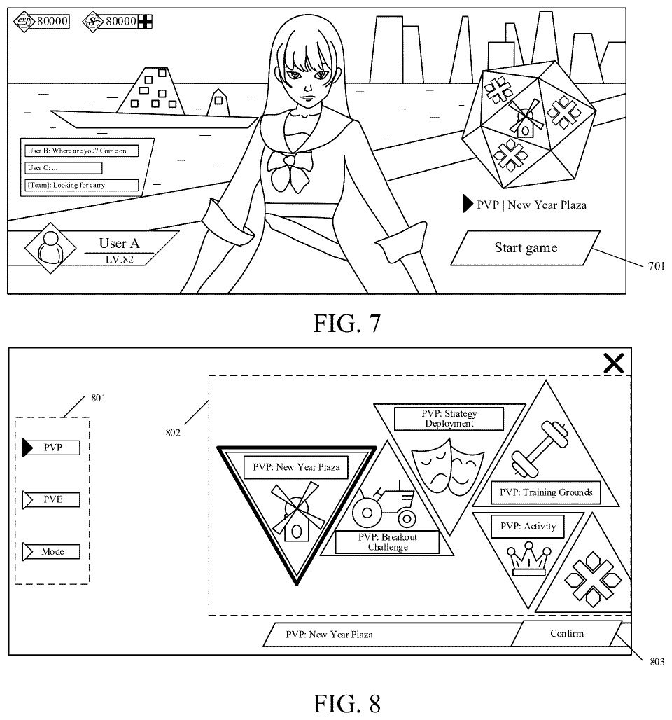

FIG. 7 is a schematic diagram of an example of a first interface according to an aspect of this disclosure. As shown in FIG. 7, when the target application is a gaming application and the first interface is a game hall interface in the gaming application, a “Start Game” button 701 in the game hall interface may be used as the second function entry control, and in response to an operation triggered by using the “Start Game” button 701, the gaming application displays a second interface corresponding to the “New Year Plaza” game mode on the display screen of the terminal device by invoking a target function “New Year Plaza” corresponding to the main display surface.

In this aspect of this disclosure, the function use operation triggered by using the second function entry control may be clicking/tapping the second function entry control, double-clicking/tapping or long-pressing the second function entry control, or may be implemented in another triggering manner. The triggering manner of the second function entry control is not specifically limited in this aspect of this disclosure.

In this way, by using the foregoing method, the second function entry control is disposed on the first interface, and the second interface corresponding to the target function is displayed in response to the function use operation triggered by using the second function entry control, to invoke the target function on the first interface, thereby simplifying an operation process of invoking the target function and improving efficiency of invoking the target function.

In a possible implementation, operation 203 may be implemented in the following manner.

Operation 71: Display an unfolding interface corresponding to the three-dimensional polyhedral control if an unfolding operation triggered for the three-dimensional polyhedral control is received in a case that the target functional face is the main display surface of the three-dimensional polyhedral control.

When the user wants to further understand each functional face in the three-dimensional polyhedral control, an unfolding operation on the three-dimensional polyhedral control may be triggered to unfold and display each functional face in the three-dimensional polyhedral control, that is, display the unfolding interface corresponding to the three-dimensional polyhedral control. The unfolding interface is an interface for displaying some or all of the functional faces in the three-dimensional polyhedral control in a form of a function tab in a tiled manner. Some or all of the foregoing functional faces include at least a functional face corresponding to the main display surface of the three-dimensional polyhedral control on the first interface. That is, the unfolding interface includes at least a target function tab corresponding to the target function. In addition, since the unfolding operation triggered for the three-dimensional polyhedral control in operation 71 is triggered in a scenario in which the function corresponding to the main display surface of the three-dimensional polyhedral control is the target function, the target function tab corresponding to the target function needs to be highlighted on the unfolding interface obtained in the scenario. That is, the target function tab needs to be in a selected state.

FIG. 8 is an unfolding interface corresponding to the three-dimensional polyhedral control on the first interface shown in FIG. 7. On the first interface, the target function corresponding to the main display surface of the three-dimensional polyhedral control is “New Year Plaza”. Therefore, as can be seen from the unfolding interface shown in FIG. 8, the target function tab corresponding to “New Year Plaza” is in the selected state.

In this aspect of this disclosure, on the unfolding interface, a stroke effect may be set on the target function tab to reflect that the target function tab is in the selected state. Another effect may alternatively be used to reflect that the target function tab is in the selected state, which is not specifically limited in this aspect of this disclosure.

Operation 72: Display the second interface corresponding to the target function in response to a start-to-use operation on the target function and triggered based on the target function tab.

On the unfolding interface, the target function tab corresponding to the target function is in the selected state. Therefore, in this case, if the user wants to directly invoke the target function, a start-to-use operation on the target function may be triggered based on the target function tab. In response to the start-to-use operation, the terminal device displays the second interface corresponding to the target function on the display screen. The second interface is a function implementation interface corresponding to the target function. When the second interface is displayed on the display screen, the target application has successfully invoked the target function and provides the target function for the user for use.

In this way, by using the foregoing method, the unfolding interface is displayed, thereby improving a presentation effect of the functional faces carried by the three-dimensional polyhedral control, facilitating the user to quickly and intuitively understand each functional face carried by the three-dimensional polyhedral control, and improving use experience of the user.

In a possible implementation, the displaying an unfolding interface corresponding to the three-dimensional polyhedral control if an unfolding operation triggered for the three-dimensional polyhedral control is received described in operation 71 may be implemented in the following manner:

playing back an unfolding animation corresponding to the three-dimensional polyhedral control if the unfolding operation triggered for the three-dimensional polyhedral control is received; and displaying the unfolding interface corresponding to the three-dimensional polyhedral control after playback of the unfolding animation is ended or a skip operation on the unfolding animation is received.

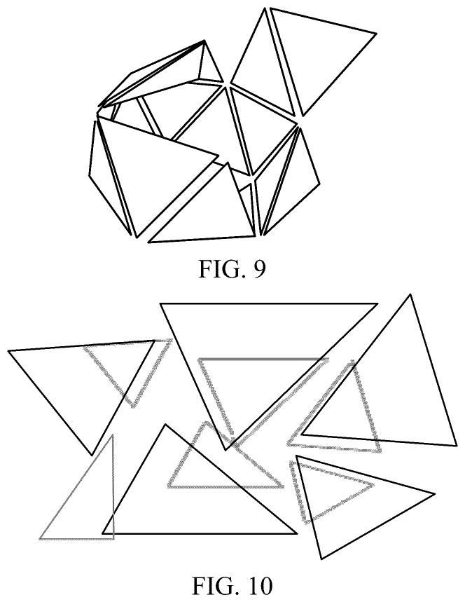

FIG. 9 and FIG. 10 are schematic diagrams of an unfolding effect of a three-dimensional polyhedral control according to an aspect of this disclosure. In FIG. 9, in response to an unfolding operation triggered for the three-dimensional polyhedral control, functional faces in the three-dimensional polyhedral control gradually unfold, connection relationships between some of the functional faces begin to break down, and the three-dimensional polyhedron model starts to gradually disintegrate. With playback of the unfolding animation, the three-dimensional polyhedral control unfolds from FIG. 9 to an effect shown in FIG. 10. In FIG. 10, a layout between function tabs on the unfolding interface is gradually clear. However, since playback of the unfolding animation is not completed, ghosting of the function tabs occurs to different degrees on the unfolding interface shown in FIG. 10. As playback of the unfolding animation ends, the ghosting corresponding to each function tab in FIG. 10 may disappear, and a clear unfolding interface corresponding to the three-dimensional polyhedral control is displayed accordingly.

In this aspect of this disclosure, different unfolding effects of different three-dimensional polyhedral controls may be implemented by setting different unfolding animations. For example, the main display surface of the three-dimensional polyhedral control is disposed in a center of the display screen, and other functional faces are successively unfolded towards two sides. Certainly, an unfolding effect of the corresponding three-dimensional polyhedral control may alternatively be reflected by using another unfolding animation (such as gradient display of a function tab), which is not specifically limited in this aspect of this disclosure.

To meet use requirements of different users, when the unfolding animation is played back, playback of the unfolding animation may further be terminated during the unfolding according to a skip operation on the unfolding animation, and further, the unfolding interface corresponding to the three-dimensional polyhedral control is directly displayed, to reduce an unfolding time of the three-dimensional polyhedral control. The skip operation may be triggered by a click/tap operation performed by the user at any position of the display screen during the playback of the unfolding animation. Alternatively, a skip control may be disposed on a playback interface of the unfolding animation, and the skip operation is further triggered in response to triggering of the skip control by the user. The foregoing descriptions are merely examples, and are not understood as a limitation on this aspect of this disclosure. A triggering manner or a triggering condition of the skip operation is not limited in this disclosure.

In this way, by using the foregoing method, by displaying an unfolding animation, a visual effect during display and unfolding of the three-dimensional polyhedral control is improved, and interactivity between the user and the three-dimensional polyhedral control is also improved.

In a possible implementation, the unfolding interface includes a type tab display region and a function tab display region; the type tab display region including type tabs respectively corresponding to a plurality of function types, where a type tab corresponding to a function type of the target function is in a selected state; and the function tab display region including function tabs corresponding to the type tab in the selected state.

The type tab display region is a region configured for displaying function types of a plurality of functions in the three-dimensional polyhedral control. The function types are classification labels obtained by classifying functions corresponding to the functional faces of the three-dimensional polyhedral control. The function tab display region is a region configured for displaying a function tab corresponding to each functional face in the three-dimensional polyhedral control. The function tab displays introduction information of a function corresponding to the functional face, including a function map and text information. The text information may include a function name and a function type of the function corresponding to the functional face.

Function tabs of different types are separately displayed on the unfolding interface by using the type tabs. On the unfolding interface, in the function tab display region, a target function tab corresponding to the target function is in the selected state. Correspondingly, in the type tab display region, a type tab corresponding to a function type of the target function also needs to be in the selected state, and based on that the type tab is in the selected state, all function tabs under the type tab need to be displayed in the function tab display region.

Referring to FIG. 8, on the unfolding interface shown in FIG. 8, a type tab display region indicated by 801 includes “PVP”, “PVE”, and “Mode” which are type tabs corresponding to three different function types. In the type tab display region 801, a type tab “PVP” corresponding to a function type of a target function “PVP: New Year Plaza” is in the selected state. Correspondingly, a function tab display region 802 includes function tabs corresponding to a “PVP” function type, that is, function tabs respectively corresponding to five different functions “PVP: New Year Plaza”, “PVP: Breakout Challenge”, “PVP: Strategy Deployment”, “PVP: Training Grounds”, and “PVP: Activity” in the “PVP” function type, and the target function tab “PVP: New Year Plaza” is in the selected state.

In this way, by using the foregoing method, the function tabs respectively corresponding to the functional faces in the three-dimensional polyhedral control are classified and displayed, which reduces a quantity of function tabs carried on an unfolding interface, simplifies an interface layout on the unfolding interface, and improves a display effect of a single function tab on the unfolding interface, thereby improving utilization of the interface space. Moreover, display of function tabs respectively corresponding to functions of different function types by using different sub-interfaces according to the function types also facilitates the user to quickly search, according to a function type, for a function tab corresponding to a function that the user needs to use, thereby improving use experience of the user and searching efficiency of the related function.

In a possible implementation, based on the unfolding interface including a type tab display region and a function tab display region, the following operations may be further performed:
receiving a selected-type switching operation triggered in the type tab display region, adjusting the type tab in the selected state in the type tab display region according to the selected-type switching operation, and adjusting a function tab in the function tab display region to a function tab corresponding to the type tab in the selected state;
and/or
receiving a selected-function switching operation triggered in the function tab display region, and adjusting a function tab in the selected state in the function tab display region according to the selected-function switching operation.

The selected-type switching operation triggered in the type tab display region is configured for switching a type tab in the selected state in the type tab display region. In response to an operation that a type tab is selected, function tabs corresponding to the type tab currently in the selected state are correspondingly displayed in the function tab display region.

The selected-type switching operation may be triggered at any position in the type tab display region, which is not specifically limited in this disclosure. At the same time, a manner of triggering the selected-type switching operation may be clicking/tapping, double-clicking/tapping, or long-pressing a type tab that needs to be selected, or may be triggered by a swipe operation in the type tab display region. The foregoing descriptions are merely examples, and a manner of triggering the selected-type switching operation is not specifically limited in this disclosure.

A selected-function switching operation triggered in the function tab display region is configured for switching a function tab in the selected state in the function tab display region. A function type of the function tab is a function type corresponding to a type tab currently in the selected state in the type tab display region.

The selected-function switching operation may be triggered at any position in the function tab display region, which is not specifically limited in this disclosure. At the same time, a manner of triggering the selected-function switching operation may be clicking/tapping, double-clicking/tapping, or long-pressing a function tab that needs to be selected, or may be triggered by a swipe operation in the function tab display region. The foregoing descriptions are merely examples, and a manner of triggering the selected-function switching operation is not specifically limited in this disclosure.

In this way, by using the foregoing method, the user may browse different type tabs and function tabs on the unfolding interface and switch the type tabs and the function tabs on a type tag-based classification display interface, thereby improving efficiency of switching the type tabs and the function tabs and helping the user to quickly determine a target function tag.

In a possible implementation, the unfolding interface further includes a first function entry control, the first function entry control supporting triggering use of a function corresponding to a function tab in the selected state. Operation 72 may be implemented in the following manner:

displaying the second interface corresponding to the target function in response to a function use operation triggered by using the first function entry control in a case that the target function tab is in the selected state.

The first function entry control is a control configured to invoke the target function on the unfolding interface. When the first function entry control is triggered, the target application invokes the target function and switches from the unfolding interface to the second interface corresponding to the target function, and the second interface is displayed on the display screen.

As an example, on the unfolding interface shown in FIG. 8, a “confirm” control 803 is deployed, and the control is the first function entry control on the unfolding interface. In response to an operation triggered by using the “confirm” control 803, the target application invokes the target function “New Year Plaza” corresponding to the currently selected target function tab “PVP: New Year Plaza”, and the second interface corresponding to “New Year Plaza” is displayed on the display screen of the terminal device.

In this aspect of this disclosure, the operation triggered by the first function entry control may be implemented by the user by clicking/tapping the first function entry control, or may be implemented by the user by double-clicking/tapping or long-pressing the first function entry control, or may be implemented in another triggering manner. The triggering manner of the first function entry control is not specifically limited in this aspect of this disclosure.

In this way, by using the foregoing method, the first function entry control is disposed on the unfolding interface, and the second interface of the target function corresponding to the target function tab currently in the selected state is displayed in response to the function use operation triggered by using the first function entry control, to accurately invoke the target function on the unfolding interface.

In a possible implementation, the function tab is associated with a use entry of a function corresponding thereto. Operation 72 may be implemented in the following manner:
displaying the second interface corresponding to the target function in response to a function use operation triggered by using the target function tab in a case that the target function tab is in the selected state.

On the unfolding interface, each function tab is associated with a use entry of a function corresponding thereto. The use entry may be considered as an invocation switch of the corresponding function. In response to triggering of the function tab, the target application invokes the function corresponding to the function tab, to achieve an effect of directly entering the function corresponding to the function tab from the function tab. That is, when the target function tab is selected, the function use operation is directly triggered for the target function tab, and the target function may be invoked from the target application, thereby displaying the second interface corresponding to the target function on the display screen of the terminal device.

In an example, a triggering manner of the function use operation may be clicking again the selected target function tab, or may be long-pressing the target function tab, or another triggering manner may be set according to an actual service requirement, to directly invoke the function by using an associated use entry in the function tab, which is not specifically limited in this aspect of this disclosure.

In this way, by using the foregoing method, a function corresponding to the function tab of the unfolding interface is directly invoked from the function tab, thereby increasing a speed of invoking the target function, simplifying an operation process, and improving function invocation efficiency on the unfolding interface.

In a possible implementation, based on the unfolding interface, the method further includes:
displaying, if a close operation triggered for the unfolding interface is received, the first interface, and displaying the three-dimensional polyhedral control on the first interface.

The close operation triggered for the unfolding interface is an operation of switching an interface displayed on the display screen from the unfolding interface back to the first interface. On the first interface, the main display surface of the three-dimensional polyhedral control is a functional face corresponding to a function tab that is in the selected state and is on the unfolding interface. In order that an operation of the user is not affected by interface switching, when switching is performed from the unfolding interface back to the first interface, the functional face corresponding to the function tab that is in the selected state and is on the unfolding interface is determined as the main display surface of the three-dimensional polyhedral control on the first interface, thereby retaining the operation of the user before the interface switching, improving efficiency of processing of the target function by the user, and improving use experience of the user.

In this aspect of this disclosure, the close operation may be triggered by an interface close control on the unfolding interface, or may be triggered by a swipe operation of the user on the display screen. For example, when the user swipes, with a finger, from an edge of the display screen of the terminal device to the center of the display screen, the close operation is triggered. Certainly, the close operation may alternatively be triggered in another manner, which is not specifically limited in this disclosure.

In this way, by using the foregoing method, the presentation effect of each function in the target application is switched from tiled presentation back to three-dimensional presentation on the first interface by using the three-dimensional polyhedral control, which can meet use requirements of different users. Moreover, when switching is performed from the unfolding interface back to the first interface, the functional face corresponding to the function tab that is in the selected state and is on the unfolding interface is determined as the main display surface of the three-dimensional polyhedral control on the first interface, which may retain the operation of the user before the interface switching and improve use experience of the user.

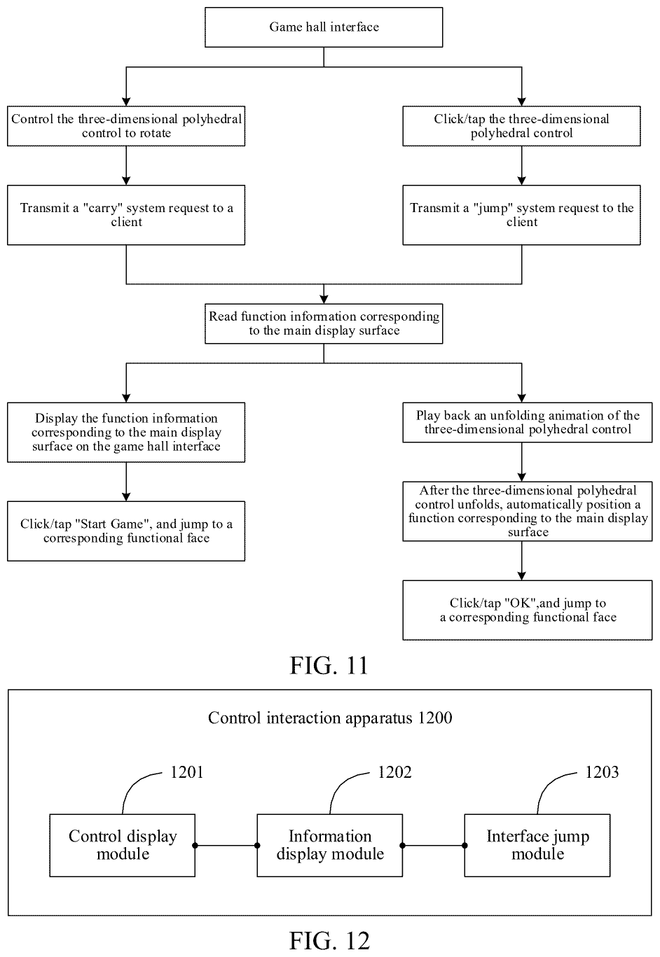

FIG. 11 is a flowchart of interaction when a three-dimensional polyhedral control is clicked/tapped and rotated according to an aspect of this disclosure. Based on the scenario shown in FIG. 1, when the first interface is a game hall interface, when a rotation operation is performed on the three-dimensional polyhedral control, the target application may transmit a system request of “switch” to the terminal device of the target application, that is, a client, and the terminal device controls, based on the system request, the three-dimensional polyhedron to rotate. Then, the terminal device reads function information corresponding to a current main display surface on the three-dimensional polyhedral control and displays the function information corresponding to the current main display surface on the game hall interface, and a function interface corresponding to the function may be entered when a button “Start Game” in the game hall is clicked/tapped. When a click/tap operation is performed on the three-dimensional polyhedral control on the game hall interface, the target application may transmit a system request of “jump” to the terminal device of the target application, and the terminal device jumps to an unfolding picture of the three-dimensional polyhedral control based on the system request. During the jumping, the terminal device reads the function information corresponding to the current main display surface of the three-dimensional polyhedral control, plays back an unfolding animation of the three-dimensional polyhedral control, and automatically positions to a function corresponding to the current main display surface after completion of playback, and a function interface corresponding to the function may be entered when an “OK” button on the unfolding interface is clicked/tapped.

FIG. 12 is a schematic structural diagram of a control interaction apparatus 1200 according to an aspect of this disclosure. As shown in FIG. 12, the apparatus includes: a control display module 1201, an information display module 1202, and an interface jump module 1203.

The control display module 1201 is configured to display a three-dimensional polyhedral control on a first interface of a target application; the three-dimensional polyhedral control including a plurality of functional faces, the plurality of functional faces corresponding to a plurality of functions in the target application.

The information display module 1202 is configured to display, when a target functional face is a main display surface of the three-dimensional polyhedral control, introduction information of a target function corresponding to the target functional face; the target functional face being any one of the plurality of functional faces, and the main display surface being a functional face on the three-dimensional polyhedral control and directly facing a display screen.

The interface jump module 1203 is configured to display a second interface corresponding to the target function if a start-to-use operation on the target function and triggered based on the target functional face is received.

In a possible implementation, the interface jump module 1203 is specifically configured to:
display an unfolding interface corresponding to the three-dimensional polyhedral control if an unfolding operation triggered for the three-dimensional polyhedral control is received in a case that the target functional face is the main display surface of the three-dimensional polyhedral control; the unfolding interface including at least a target function tab corresponding to the target function, and the target function tab being in a selected state; and
display the second interface corresponding to the target function in response to a start-to-use operation on the target function and triggered based on the target function tab.

In a possible implementation, the interface jump module 1203 is specifically configured to:
play back an unfolding animation corresponding to the three-dimensional polyhedral control if the unfolding operation triggered for the three-dimensional polyhedral control is received; and display the unfolding interface corresponding to the three-dimensional polyhedral control after playback of the unfolding animation is ended or a skip operation on the unfolding animation is received.

In a possible implementation, the unfolding interface includes a type tab display region and a function tab display region; the type tab display region including type tabs respectively corresponding to a plurality of function types, where a type tab corresponding to a function type of the target function is in a selected state; and the function tab display region including function tabs corresponding to the type tab in the selected state.

In a possible implementation, the apparatus further includes a functional face switching module, configured to:
receive a selected-type switching operation triggered in the type tab display region, adjust the type tab in the selected state in the type tab display region according to the selected-type switching operation, and adjust a function tab in the function tab display region to a function tab corresponding to the type tab in the selected state;
and/or
receive a selected-function switching operation triggered in the function tab display region, and adjust a function tab in the selected state in the function tab display region according to the selected-function switching operation.

In a possible implementation, the unfolding interface further includes a first function entry control, the first function entry control supporting triggering use of a function corresponding to a function tab in the selected state; and the interface jump module 1203 is specifically configured to:
display the second interface corresponding to the target function in response to a function use operation triggered by using the first function entry control in a case that the target function tab is in the selected state.

In a possible implementation, the function tab is associated with a use entry of a function corresponding thereto; and the interface jump module 1203 is specifically configured to:
display the second interface corresponding to the target function in response to a function use operation triggered by using the target function tab in a case that the target function tab is in the selected state.

In a possible implementation, the interface jump module 1203 is further configured to:
display, if a close operation triggered for the unfolding interface is received, the first interface, and display the three-dimensional polyhedral control on the first interface; and the main display surface of the three-dimensional polyhedral control is a functional face corresponding to a function tab in the selected state and on the unfolding interface.

In a possible implementation, the first interface includes a second function entry control; the second function entry control supporting triggering use of a function corresponding to the main display surface of the three-dimensional polyhedral control; and the interface jump module 1203 is specifically configured to:
display the second interface corresponding to the target function in response to a function use operation triggered by using the second function entry control in a case that the target functional face is the main display surface of the three-dimensional polyhedral control.

In a possible implementation, the information display module 1202 is specifically configured to:
display a function map corresponding to the target function on the main display surface of the three-dimensional polyhedral control; and
display text information corresponding to the target function in a polyhedron-associated region of the first interface; a display position of the polyhedron-associated region being determined according to a display position of the three-dimensional polyhedral control.

In a possible implementation, the information display module 1202 is further configured to:
display a default map on another functional face in the three-dimensional polyhedral control other than the target functional face in a case that the target functional face is the main display surface of the three-dimensional polyhedral control; the default map being different from the function map.

In a possible implementation, the apparatus further includes a control rotation module, configured to:
control, in response to a main display surface adjustment operation triggered for the three-dimensional polyhedral control, the three-dimensional polyhedral control to rotate to adjust a functional face that is used as the main display surface, and display introduction information of a function corresponding to the functional face that is used as the main display surface.

In a possible implementation, the control rotation module is specifically configured to:
receive a swipe operation triggered by a control object on the display screen;
determine a rotation direction and a rotation angle of the three-dimensional polyhedral control according to a swipe direction and a swipe distance that correspond to the swipe operation; and
control, based on the rotation direction and the rotation angle, the three-dimensional polyhedral control to rotate.

In a possible implementation, the control rotation module is specifically configured to:
receive a click/tap operation triggered by a control object in a control region corresponding to the three-dimensional polyhedral control; and
control, according to the click/tap operation and a rotation direction and a rotation angle that correspond to a preset click/tap operation, the three-dimensional polyhedral control to rotate.

In a possible implementation, the apparatus further includes a main display surface determination module, configured to:
determine, for each functional face of the three-dimensional polyhedral control after the three-dimensional polyhedral control stops rotating, an angle between the functional face and a horizontal plane of the display screen as a reference angle corresponding to the functional face; and
determine, in the functional faces included in the three-dimensional polyhedral control, a functional face whose corresponding reference angle is closest to zero degree as the main display surface.

In a possible implementation, the control rotation module is further configured to:
control, if the reference angle corresponding to the functional face that is used as the main display surface is not zero degree, the three-dimensional polyhedral control to rotate to cause the reference angle corresponding to the functional face that is used as the main display surface to be zero degree.

Aspects of this disclosure further provide an electronic device. The device may specifically be a terminal device or a server. The following describes the terminal device and the server provided in the aspects of this disclosure from the perspective of hardware materialization.

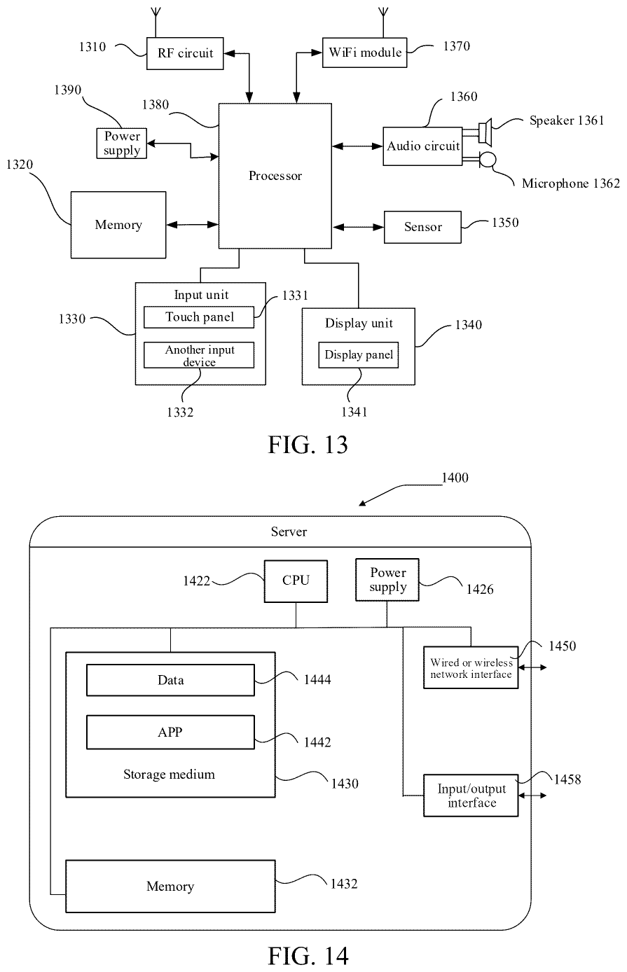

FIG. 13 is a schematic structural diagram of a terminal device according to an aspect of this disclosure. As shown in FIG. 13, for ease of description, only parts related to this aspect of this disclosure are shown. For specific technical details not disclosed, reference is made to the method part of the aspects of this disclosure. The terminal may be any terminal device including a mobile phone, a tablet computer, a personal digital assistant (PDA), a sales terminal (POS), or a vehicle-mounted computer. In an example in which the terminal is a computer,

FIG. 13 is a block diagram of a part of a structure of a computer related to the terminal provided in this aspect of this disclosure. Referring to FIG. 13, the computer includes: components such as a radio frequency (RF) circuit 1310, a memory 1320, an input unit 1330 (including a touch panel 1331 and another input device 1332), a display unit 1340 (including a display panel 1341), a sensor 1350, an audio circuit 1360 (connected to a speaker 1361 and a microphone 1362), a WiFi module 1370, processing circuitry, such as a processor 1380, and a power supply 1390. A person skilled in the art may understand that the structure of the computer shown in FIG. 13 does not constitute a limitation on the computer, which may include more or fewer components than those shown in the figure, or some merged components, or different component arrangements.

The memory 1320 may be configured to store a software program and a module. The processor 1380 runs the software program and the module stored in the memory 1320, to implement various functional applications and data processing of the computer. The memory 1320 may mainly include a program storage region and a data storage region. The program storage region may store an operating system and an APP that is required by at least one function (for example, a sound playback function and an image playback function). The data storage region may store data (for example, audio data and a phone book) created according to use of the computer. In addition, the memory 1320 may include a high-speed random access memory, and may alternatively include a non-volatile memory, such as at least one magnetic disk storage device, a flash memory, or another volatile solid-state storage device.

The processor 1380 is a control center of the computer, is connected to all parts of the entire computer by using various interfaces and lines, and executes various functions of the computer and performs data processing by running or executing the software program and/or the module stored in the memory 1320 and invoking data stored in the memory 1320. In some aspects, the processor 1380 may include one or more processing units. Preferably, the processor 1380 may integrate an application processor and a modem processor. The application processor mainly processes an operating system, a user interface, an APP, and the like. The modem processor mainly processes wireless communication. The modem processor may not be integrated into the processor 1380.

In this aspect of this disclosure, the processor 1380 is further configured to perform operations of any one implementation of the control interaction method provided in the aspects of this disclosure.

FIG. 14 is a structural schematic diagram of a server 1400 according to an aspect of this disclosure. The server 1400 may vary greatly because of different configurations or performance, and may include one or more central processing units (CPUs) 1422 (for example, one or more processors), a memory 1432, and one or more storage media 1430 (for example, one or more mass storage devices) that store an APP 1442 or data 1444. The memory 1432 and the storage medium 1430 may be transient or persistent storages. A program stored in the storage medium 1430 may include one or more modules (not shown), and each module may include a series of instruction operations on the server. Furthermore, the CPU 1422 may be configured to communicate with the storage medium 1430, and perform, on the server 1400, the series of instruction operations on the storage medium 1430.

The server 1400 may further include one or more power supplies 1426, one or more wired or wireless network interfaces 1450, one or more input/output interfaces 1458, and/or one or more operating systems, such as Windows Server™, Mac OS X™, Unix™, Linux™, and FreeBSD™.

Operations performed by the server in the foregoing aspects may be based on the structure of the server shown in FIG. 14.

The CPU 1422 may be further configured to perform operations of any one implementation of the control interaction method provided in the aspects of this disclosure.

Aspects of this disclosure further provide a computer-readable storage medium, such as a non-transitory computer-readable storage medium, configured to store a computer program. The computer program is configured for performing any one of the implementations of the control interaction method according to the foregoing aspects.

Aspects of this disclosure further provide a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, causing the computer device to perform any one implementation of the control interaction method described in the foregoing aspects.

A person skilled in the art can understand that for convenience and conciseness of description, for specific working processes of the foregoing systems, devices and units, reference may be made to the corresponding processes in the foregoing method aspects, and details are not described herein again.

In the several aspects provided in this disclosure, the disclosed system, apparatus, and method may be implemented in other manners. For example, the described apparatus aspect is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the aspects.

In addition, functional units in the aspects of this disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this disclosure may be implemented in the form of a software product. The computer software product is stored in a storage medium and includes several instructions for instructing a computer device (which may be a personal computer, a server, a network device, or the like) to perform all or some of the steps of the methods described in the aspects of this disclosure. The foregoing storage medium includes: various media capable of storing program codes, such as a read-only memory (ROM), a random access memory (RAM), a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In this disclosure, “at least one” means one or more, and “a plurality of” means two or more. The term “and/or” is used for describing an association relationship between associated objects and representing that three relationships may exist. For example, “A and/or B” may represent the following three cases: Only A exists, both A and B exist, and only B exists, where A and B may be singular or plural. The character “/” indicates an “or” relationship between the associated objects. “At least one of the following items” or a similar expression means any combination of these items, including a single item or any combination of a plurality of items. For example, at least one of a, b, or c may represent a, b, c, “a and b”, “a and c”, “b and c”, or “a, b, and c”, where a, b, and c may be singular or plural.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Based on the above, the foregoing aspects are merely intended to describe examples of the technical solutions of this disclosure, and are not intended to limit this disclosure. Although this disclosure is described with reference to the foregoing aspects, a person of ordinary skill in the art may understand that modifications may still be made to the technical solutions described in the foregoing aspects, or equivalent replacements may be made to the part of the technical features. Such modifications or replacements do not cause the essence of the corresponding technical solutions to depart from the spirit and scope of the technical solutions of the aspects of this disclosure.

What is claimed is:

1. A control interaction method, comprising:
displaying, on a first user interface of an application, a three-dimensional polyhedral control element that includes a plurality of functional faces, each of the plurality of functional faces corresponding to a respective one of a plurality of functions provided by the application;
displaying, for a target functional face of the plurality of functional faces that is a front-facing display surface of the three-dimensional polyhedral control element, function information of a target function that corresponds to the target functional face; and
performing the target function based on a first selection operation being performed on the target functional face of the three-dimensional polyhedral control element.

2. The method according to claim 1, further comprising:
displaying an unfolded user interface corresponding to the three-dimensional polyhedral control element based on an unfolding operation, the unfolded user interface including a first function element corresponding to the target function and a second function element corresponding to another function of the plurality of functions on a same plane, the first function element being displayed in a selected state.

3. The method according to claim 2, wherein the displaying the unfolded user interface comprises:
displaying an unfolding animation of the three-dimensional polyhedral control element.

4. The method according to claim 2, wherein
the unfolded user interface includes a type display region and a function display region;
the type display region includes a plurality of type elements of a plurality of function types, a first type element of the plurality of type elements that corresponds to the function type of the target function being displayed in a selected state; and
the function display region includes function elements of the plurality of functions that correspond to the function type of the first type element.

5. The method according to claim 4, further comprising:
receiving a second selection operation on a second type element of the plurality of type elements in the type display region; and
displaying function elements of the plurality of functions that correspond to the function type of the second type element in the function display region.

6. The method according to claim 2, wherein
the unfolded user interface further includes a first function entry control element; and
the method further comprises:
performing the target function based on a third selection operation being performed on the first function entry control element when the first function element is in the selected state.

7. The method according to claim 2, further comprising:
based on a close operation being performed for the unfolded user interface, displaying the three-dimensional polyhedral control element, wherein
the front-facing display surface of the three-dimensional polyhedral control element is determined based on which of a plurality of function elements in the unfolded user interface is in the selected state.

8. The method according to claim 1, wherein
the first user interface includes a second function entry control element; and
the performing the target function comprises:
performing the target function based on a fourth selection operation being performed on the second function entry control element.

9. The method according to claim 1, wherein the displaying the function information comprises:
displaying a function map corresponding to the target function on the front-facing display surface of the three-dimensional polyhedral control element; and
displaying text information corresponding to the target function in a polyhedron-associated region of the first user interface.

10. The method according to claim 9, further comprising:
displaying a default map on another functional face of the plurality of functional faces on the three-dimensional polyhedral control element when the target functional face is the front-facing display surface, the default map being different from the function map.

11. The method according to claim 1, further comprising:
based a front-facing display surface adjustment operation being performed on the three-dimensional polyhedral control element, controlling the three-dimensional polyhedral control element to rotate and change the front-facing display surface to another one of the plurality of functional faces on the three-dimensional polyhedral control element.

12. The method according to claim 11, wherein the controlling the three-dimensional polyhedral control element to rotate comprises:
receiving a swipe operation;
determining a rotation direction and a rotation angle of the three-dimensional polyhedral control element according to a swipe direction and a swipe distance of the swipe operation; and
controlling the rotation of the three-dimensional polyhedral control element based on the determined rotation direction and the determined rotation angle.

13. The method according to claim 11, wherein the controlling the three-dimensional polyhedral control element to rotate comprises:
receiving a fifth selection operation in a control region corresponding to the three-dimensional polyhedral control element; and
rotating the three-dimensional polyhedral control element according to a preset rotation direction and angle associated with the fifth selection operation.

14. The method according to claim 11, wherein the another one of the plurality of functional faces is determined based on which of a plurality of angles between the plurality of functional faces and a horizontal plane of a display screen is closest to zero degrees.

15. The method according to claim 14, further comprising:
controlling, when the angle between the another one of the plurality of functional faces and the horizontal plane is not zero degrees, the three-dimensional polyhedral control element to further rotate to adjust the angle to zero degrees.

16. A information processing apparatus, comprising:
processing circuitry configured to:
display, on a first user interface of an application, a three-dimensional polyhedral control element that includes a plurality of functional faces, each of the plurality of functional faces corresponding to a respective one of a plurality of functions provided by the application;
display, for a target functional face of the plurality of functional faces that is a front-facing display surface of the three-dimensional polyhedral control element, function information of a target function that corresponds to the target functional face; and
perform the target function based on a first selection operation being performed on the target functional face of the three-dimensional polyhedral control element.

17. The information processing apparatus according to claim 16, wherein the processing circuitry is configured to:
display an unfolded user interface corresponding to the three-dimensional polyhedral control element based on an unfolding operation, the unfolded user interface including a first function element corresponding to the target function and a second function element corresponding to another function of the plurality of functions on a same plane, the first function element being displayed in a selected state.

18. The information processing apparatus according to claim 17, wherein the processing circuitry is configured to:
display an unfolding animation of the three-dimensional polyhedral control element.

19. The information processing apparatus according to claim 17, wherein
the unfolded user interface includes a type display region and a function display region;
the type display region includes a plurality of type elements of a plurality of function types, a first type element of the plurality of type elements that corresponds to the function type of the target function being displayed in a selected state; and
the function display region includes function elements of the plurality of functions that correspond to the function type of the first type element.

20. A non-transitory computer-readable storage medium storing instructions which when executed, cause at least one processor to:
display, on a first user interface of an application, a three-dimensional polyhedral control element that includes a plurality of functional faces, each of the plurality of functional faces corresponding to a respective one of a plurality of functions provided by the application;
display, for a target functional face of the plurality of functional faces that is a front-facing display surface of the three-dimensional polyhedral control element, function information of a target function that corresponds to the target functional face; and
perform the target function based on a first selection operation being performed on the target functional face of the three-dimensional polyhedral control element.
